(19) United States
(12) Patent Application Publication
(10) Pub. No.: US 2005/0033583 A1
(43) Pub. Date: Feb. 10, 2005

(54) Processing transactions using a structured natural language

(76) Inventors: Heather Ellen Bergeron, Westminster, MA (US); Chris Easton, Andover, MA (US); Kunjan Jhaveri, Woburn, MA (US); Andrew Kennedy, Needham, MA (US); James Kennedy, Houston, TX (US); Jayant Pai, Acton, MA (US); Alon Peled, Newton Center, MA (US); Simone Lemos Pringle, Sudbury, MA (US); Benjamin Sprecher, Grafton, MA (US); John Trustman, Gloucester, MA (US)

Correspondence Address: FOLEY HOAG, LLP;PATENT GROUP, WORLD TRADE CENTER WEST, 155 SEAPORT BLVD, BOSTON, MA, 02110, US

(21) Appl. No.: 10/656,909

(22) Filed: Sep. 5, 2003

Related U.S. Application Data
(63) Continuation-in-part of application No. 10/642,126, filed on Aug. 15, 2003.
Application No. 10/642,126 is a continuation of application No. 10/382,480, filed on Mar. 6, 2003, now abandoned.
Application No. 10/382,480 is a continuation of application No. 10/185,945, filed on Jun. 28, 2002, now abandoned.
Application No. 10/382,480 is a continuation-in-part of application No. 09/833,097, filed on Apr. 10, 2001.
(60) Provisional application No. 60/499,322, filed on Aug. 29, 2003.
(60) Provisional application No. 60/301,698, filed on Jun. 28, 2001.
(60) Provisional application No. 60/221,173, filed on Jul. 27, 2000.
(60) Provisional application No. 60/223,845, filed on Aug. 8, 2000.
(60) Provisional application No. 60/258,969, filed on Dec. 29, 2000.

(51) Int. Cl. G10L 11/00

(52) U.S. Cl. 704/277

(57) ABSTRACT

The disclosed technology can identify indicia associated with different entity types that interact within an industry, identify one or more relationships (e.g., contractual provisions) that can affect interactions between such entity types, and identify transactions associated with one or more of the interactions. Further, the identified transactions can be organized into one or more transaction sequences. The identified indicia, the one or more identified relationships, and the one or more transaction sequences can then be associated to form a semantic network. An instance of the semantic network can be formed in response to the execution of at least some of the transaction sequence and can serve, at least in part, as the basis for processing requests associated with the entities. The requests can correspond to interactions associated with the entities and may be represented in a natural language format, exhibiting a fixed context and a fixed grammar.

### CLAIM OF PRIORITY

This is a nonprovisional of U.S. Provisional Patent Application No. __/______, entitled “Processing Transactions Using a Semantic Network,” filed on Aug. 29, 2003 and identified by Attorney Docket No. EHP-003.60. This is also a continuation-in-part of co-pending U.S. Utility patent application Ser. No. 10/______, entitled “Semantic Network,” filed Aug. 15, 2003 and identified by Attorney Docket No. EHP-002.03, which is a continuation of U.S. Utility patent application Ser. No. 10/382,480, filed Mar. 6, 2003. application Ser. No. 10/382,480 is a continuation of U.S. Utility patent application Ser. No. 10/185,945, filed Jun. 28, 2002. application Ser. No. 10/185,945 is a nonprovisional of U.S. Provisional Patent Application No. 60/301,698, filed Jun. 28, 2001 and is a continuation-in-part of U.S. Utility patent application Ser. No. 09/833,097, filed Apr. 10, 2001. application Ser. No. 09/833,097 is a nonprovisional of U.S. Provisional Patent Application Nos. 60/221,173, filed Jul. 27, 2000; 60/223,845, filed Aug. 8, 2000; and 60/258,969, filed Dec. 29, 2000. This claims priority to and the benefit of the patent applications identified above and these applications are also incorporated herein by reference in their entirety.

### RELATED APPLICATIONS

This is also related to the following co-pending and concurrently-filed U.S. Utility Patent Application Nos., the entirety of which are incorporated herein by reference:
Ser. No. 10/______, “Configuring a Semantic Network to Process Transactions,” identified by Attorney Docket No. EHP-003.01; and Ser. No. 10/______, “Processing Transactions Using a Semantic Network,” identified by Attorney Docket No. EHP-003.02.

### TECHNICAL FIELD

The disclosed technology relates generally to transaction processing and more particularly to transaction processing using a semantic network.

### BACKGROUND

Continuing budgetary and competitive pressures to reduce costs and increase revenues have traditionally motivated decision makers in business, government, and other organizational entities to develop systems that automate a variety of organizational processes. Historically, these automated systems were custom designed as standalone systems that did not readily lend themselves to integration with other such systems. As such systems proliferated and organizations became increasingly dependent on them, efforts were made to develop interface software that would enable such systems to communicate and to thereby provide enterprise-wide automation. Unfortunately, the complexity and inflexibility of the interface software further compound the difficulty and expense in maintaining these systems such that even relatively minor reconfiguration changes pose significant redevelopment challenges.

The challenges in maintaining and updating systems that have been custom designed for internal purposes within an organization are further exacerbated when such systems are required to interface with those of other organizations, as may occur between organizational entities that frequently interact with each other (e.g., trading partners). In order for trading partners or other collaborating entities to leverage their individual strengths for mutual advantage, business-to-business software applications must be developed to interface their disparate systems so that electronic documents and/or other data can be communicated therebetween to facilitate electronic commerce. As may be expected, changes in the operations of either entity or in the business relationship between entities may necessitate changes to one or more of the custom-designed systems of each entity, as well as changes to their interconnecting business-to-business software applications. Accordingly, trading partners and/or other collaborating entities have a continuing interest in developing flexible systems/architectures that can be readily adapted to accommodate changes in their operations and interactions.

### SUMMARY

The disclosed technology can represent attributes and/or interrelationships associated with industry participants in one or more semantic networks to facilitate the interaction therebetween. A semantic network can provide a logical construct that represents what an industry contains (e.g., types of industry participants, contract provisions controlling the interaction between such participants, etc.) and how the industry functions (e.g., the relationships, interactions, and transactions associated with types of industry participants).

Particular instances of a semantic network can serve as a point of reference for one or more industry participants and can represent at least some of the relationships, interactions, and transactions occurring among and between such industry participants. Changes affecting interactions of particular industry participants (such as, for example, changes in contract provisions, changes pertaining to industry participants themselves, etc.) can be readily accommodated by representing such changes in a natural language format (exhibiting, for example, a fixed context and a fixed grammar). The natural language format of the changes can be understood by decision makers of the industry participants, as well as, by one or more software processes that modify the underlying data structures that represent the industry participants and their relationships, interactions, transactions, etc. Accordingly, future instances of a semantic network can reflect any such changes with a reduced chance of human error and without requiring extensive (manual) modifications to existing systems and software.

In one embodiment, the disclosed technology can be used to develop systems and perform methods that can identify indicia associated with different entity types that interact within an industry, identify one or more relationships (corresponding to, for example, one or more contractual provisions) that can affect interactions between such entity types (e.g., a request for payment of services performed, a request to authorize proposed services, a request to enroll a service provider, a request to enroll a service purchaser, a request to enroll a service beneficiary, an adoption of a new contract, etc.), and identify transactions associated with one or more of the interactions. The identified indicia can be received from an electronic data interchange system, an application program interface, a user interface, and/or a software editing tool and can be represented in a natural language format exhibiting, for example, a fixed context and a fixed grammar (e.g., Backus-Naur format). The fixed context can be based, at least in part, on an industry-specific data structure that can be used to identify operations associated with the transactions. The natural language representation of the identified indicia can be parsed into fields, where at least some of these fields can be mapped and/or stored into one or more data structures to which a version number can be assigned. An electronic message can be formed in response to a detection of an error associated with the identified indicia. Further, the identified transactions can be organized into one or more transaction sequences.

The identified indicia, the one or more identified relationships, and the one or more transaction sequences can then be associated to form a semantic network, where an instance of the semantic network is formable based, at least in part, on a detection of the one or more interactions. The semantic network can include nodes corresponding to the identified indicia, as well as, links interconnecting at least some of these nodes, which may be based on one or more of the identified relationships. Data structures associated with the semantic network can also be queried to obtain at least some of the identified indicia and data associated with the relationships and such query results can be contained within an electronic document, which may be viewable in a natural language format that exhibits, for example, a fixed context and a fixed grammar.

The disclosed technology can support a variety of industry types, such as, a service-based industry, a health care industry, a product-based industry, etc. By way of non-limiting example, the two different entities in a service-based industry can correspond to service providers, service implementers, service purchasers, service beneficiaries, service maintainers, and/or service regulators. In a health care industry embodiment, the two different entities can, for example, correspond to health care subscribers, health care providers, health care practitioners, health care beneficiaries, and/or health care companies. Similarly, the two different entities in a product-based industry can, for example, correspond to product manufacturers, product distributors, product resellers, product marketers, product sellers, product purchasers, product maintainers, and/or product regulators.

In one embodiment, the disclosed technology can be used to develop systems and perform methods in which a request associated with two or more different entities interacting in an industry can be received and a sequence of transactions associated with the request can be identified. At least some of the transaction sequence can be executed to form an instance of a semantic network that includes one or more relationships between the entities (corresponding to, for example, a contractual provision associated with the entities) and the request can be processed based, at least in part, on the semantic network. The request can, for example, correspond to a request for payment of services performed, a request to authorize proposed services, a request to enroll a service provider, a request to enroll a service purchaser, a request to enroll a service beneficiary, a request to adopt a new contract, etc. The request can be received from an electronic data interchange system, an application program interface, a user interface, and/or a software editing tool and can be represented in a natural language format exhibiting, for example, a fixed context and a fixed grammar (e.g., Backus-Naur format). The fixed context can be based, at least in part, on an industry-specific data structure that can be used to identify operations associated with the transaction sequence. The natural language representation of the request can be parsed into fields, where at least some of these fields can be mapped and/or stored into one or more data structures. A version number can be assigned to these data structures to enable the re-execution of at least some of the transaction sequence when reprocessing the request. An electronic message can be formed in response to a detection of an error occurring during the execution of the transaction sequence.

The semantic network can include nodes corresponding to the indicia associated with the entities, as well as, links interconnecting at least some of these nodes, which may be based on one or more relationships. Data structures associated with the semantic network can also be queried to obtain indicia associated with the entities and the relationships, and such query results can be contained within an electronic document, which may be viewable in a natural language format that exhibits, for example, a fixed context and a fixed grammar.

In one embodiment, the disclosed technology can be used to develop systems and perform methods in which a request to change a relationship associated with entities interacting in an industry can be received and parsed to identify a data structure associated with the industry, where the data structure includes entity types and relationship types. A sequence of transactions can be identified based on at least some of the entity types and relationship types that correspond to the entities. The transaction sequence can then be executed to process the requested relationship change (corresponding to, for example, one or more contractual provisions associated with the entities). The request can, for example, correspond to a request for payment of services performed, a request to authorize proposed services, a request to enroll a health care provider, a request to enroll a health care subscriber, a request to enroll a health care beneficiary, a request to adopt a new contract, etc. The request can be received from an electronic data interchange system, an application program interface, a user interface, and/or a software editing tool and can be represented in a natural language format in an electronic document exhibiting, for example, a fixed context and a fixed grammar (e.g., Backus-Naur format). The natural language representation of the request can be parsed into fields, where at least some of these fields can be mapped and/or stored into one or more first data structures/database tables. A version number can also be assigned to these data structures to enable the re-execution of at least some of the transaction sequence when reprocessing the requested relationship change. An electronic message can be formed in response to a detection of an error occurring during the execution of the transaction sequence.

The semantic network can include nodes corresponding to the indicia associated with the entities, as well as, links interconnecting at least some of these nodes, which may be based on the requested relationship change. An instance of the semantic network can be formed in response to the execution of at least part of the transaction sequence. Data structures associated with the semantic network can also be queried to obtain data associated with the entities and the requested relationship change, and at least some of the obtained data can be formatted in a natural language format that exhibits, for example, a fixed context and a fixed grammar.

### BRIEF DESCRIPTION OF THE DRAWINGS

The foregoing discussion will be understood more readily from the following detailed description of the disclosed technology, when taken in conjunction with the accompanying drawings in which:

FIG. 1 schematically illustrates an exemplary collaboration architecture;

FIG. 2 illustrates an exemplary methodology that may be performed in a modeling an industry using a semantic network;

FIG. 3 illustrates an exemplary methodology that may be performed in a configuring a an industry model based on a semantic network;

FIG. 4 illustrates an exemplary structured natural language representation of a health care benefit that may relate to a relationship between entities in a semantic network;

FIG. 5 illustrates an exemplary methodology that may be performed when processing requests using a semantic network;

FIG. 6 illustrates an exemplary high-level representation of a semantic network instance associated with an exemplary health care embodiment; and

FIG. 7 illustrates an exemplary high-level representation of another semantic network instance that provides varying detail relative to the semantic network instance of FIG. 6.

### DETAILED DESCRIPTION

Unless otherwise specified, the illustrated embodiments can be understood as providing exemplary features of varying detail of certain embodiments, and therefore, unless otherwise specified, features, components, processes, modules, data elements, and/or aspects of the illustrations can be otherwise combined, interconnected, sequenced, separated, interchanged, and/or rearranged without departing from the disclosed systems or methods. Additionally, the shapes, sizes, and orientations of elements are also exemplary and unless otherwise specified, can be altered without affecting the disclosed technology.

For the purposes of this disclosure, the term “substantially” can be broadly construed to indicate a precise relationship, condition, arrangement, orientation, and/or other characteristic, as well as, deviations thereof as understood by one of ordinary skill in the art, to the extent that such deviations do not materially affect the disclosed methods and systems.

For the purposes of this disclosure, the term “software process” can refer to a set of executable instructions, operations, variables, parameters, data, data structures, software drivers, plug-ins, and/or any other type of elements that are needed to form an execution environment sufficient to perform the desired functionality of the process. Those skilled in the art will recognize that the functionality described for a particular software process can be incorporated into one or more other processes and that the software processes themselves can be otherwise combined, separated, and/or organized without adversely affecting the operation of the disclosed technology and thus are intended merely for illustrative purposes. The term, “data structure,” can refer to a database table, a linked list, and/or any other type of data format or configuration that enables a data set to be referenced.

Industry participants (e.g., individuals, organizations, associations, and/or other types of entities), desiring to improve their profitability and/or efficiency, recognize that collaboration technologies enable such participants to exchange mission-critical information that can be processed and/or otherwise manipulated based on the individual strengths of such participants, thereby resulting in a “virtual enterprise” that provides efficiencies and value beyond that which would otherwise be provided by distinct participants. In order to realize this value, collaboration technologies, such as electronic data interchange (“EDI”) systems and enterprise application integration (“EAI”) toolsets, have been developed to facilitate the transfer of electronic data (corresponding to the mission-critical information) between the systems and/or application programs associated with the industry participants.

Implementing collaboration technologies for industry participants who have been interacting for a significant time period, who engage in a large number of transactions, and/or who engage in complex transactions can involve a significant upfront effort in configuring such technology implementations, as well as, in significant and continuing effort and cost in maintaining/updating these technology implementations as modifications in the operations and/or business rules and policies of one or more of the industry participants are encountered over time. Although the configuration effort for new industry participants is somewhat alleviated relative to that of established participants, the continuing effort and expense in maintaining/updating these technology implementations remain.

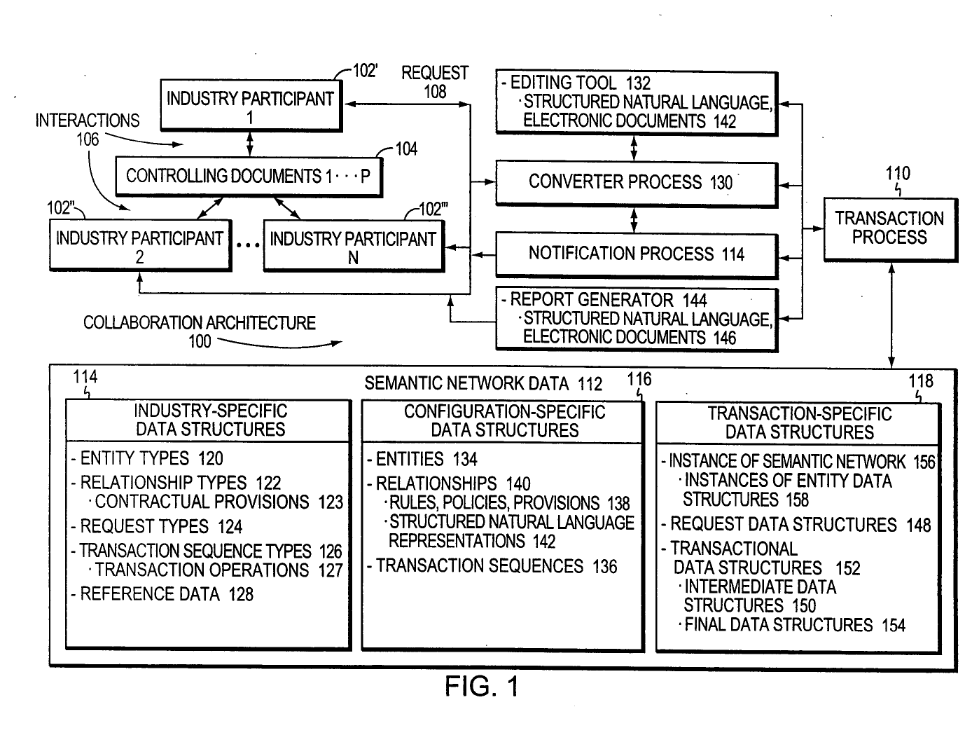

The disclosed technology can be used to develop collaboration architectures 100 (FIG. 1) in which industry participants, as well as, their interactions, transactions, and controlling business rules/policies are modeled in one or more semantic networks to support the operations of the industry participants, while concurrently reducing the effort and cost associated with maintaining/updating such architectures. A semantic network can refer to a logical construct that represents what an industry contains (e.g., types of industry participants, contract provisions controlling the interactions between such participants, etc.) and how the industry functions (e.g., the relationships, interactions, and transactions associated with types of industry participants). Following an initial configuration period in which attributes and/or other data associated with the industry participants and their interactions are stored in particular data structures, corresponding to, for example, nodes in a semantic network, the disclosed technology can represent the controlling business rules/policies (corresponding to, for example, provisions in one or more contracts/agreements) that affect the interactions of such participants in a structured natural language that corresponds to, for example, the links and related transactions that interconnect/interrelate the nodes of the semantic network. Representation of the controlling business rules/policies in a structured natural language enables decision makers of the industry participants, as well as, one or more software processes that modify the underlying data structures of the semantic network to understand such rules/policies, which facilitates modifications to the collaboration architecture when changes to the rules/policies are encountered in the future.

Those skilled in the art will recognize that the disclosed technology can be applied to a wide variety of industries, such as, for example, product-based industries, service-based industries, and/or combinations or hybrids thereof. A product-based industry can refer to an industry that is primarily focused on making and providing products to customers, although some amount of service may be involved as part of a product sale. A service-based industry can refer to an industry that is primarily focused on providing services to customers, although a product may be involved as part of a service.

The industry participants in product-based industries can include, for example, product manufacturers who make and/or assemble products, product distributors who distribute products to product resellers and/or product sellers, product resellers and product sellers who sell products to businesses and/or individuals, product marketers who advertise and/or otherwise promote products, product purchasers such as individuals and businesses that purchase products, product maintainers that service and maintain the products following a sale, and/or product regulators who may be industry groups or governmental entities that control the use and/or manufacture of products. Similarly, the industry participants in service-based industries can include, for example, service providers who arrange for services to be performed, service implementers who actually perform services, service purchasers who pay for services, service beneficiaries who receive and/or otherwise benefit from services, service maintainers who provide follow-on services after an initial service has been provided, and/or service regulators who may be industry/professional groups or governmental entities that control and/or monitor services.

By way of non-limiting example, a service-based industry can correspond to a health care industry whose participants can include, for example, one or more health care companies, health care purchasers, health care members, health care practitioners/physicians, health care suppliers and/or other individual and/or organizational legal entities whose interactions are based on one or more health care products, health care plans, health care plan contracts, benefit plans health care subscriptions, health care member service agreements, health care supplier contracts, health care supplier invoices, and/or health care policies. A health care company can refer to an organization that establishes contractual relationships with health care suppliers (also referred to herein as health care providers), practitioners/physicians, suppliers, and purchasers to coordinate the financing and delivery of medical care to enrolled members (also referred to herein as health care beneficiaries). A health care purchaser can refer to a group, employer, or an individual (in the case of Medicare) that purchases a health care plan from a health care company. A health care member can refer to an individual who receives health care plan benefits through a health care subscription. A health care practitioner/physician can refer to an individual health care giver who actually renders a service to a member. A health care supplier can refer to an organization, such as a group practice, hospital, or pharmacy that receives payment for medical services provided to a member by its affiliated health care practitioners. A health care product can refer to a template identifying particular benefits and coverage, as well as, the rules and procedures under which those benefits are available. Health care purchasers purchase customized health care plans that are based on a particular product (e.g., Health Maintenance Organizations (“HMOs”), Preferred Provider Organizations (“PPOs”), and Point of Service offerings (“POSs”). A health care plan contract can refer to a legal agreement between a purchaser and a health care company that defines rates (e.g., premiums), fees, policies, and benefits (Benefit Plan) available to subscribers. A benefit plan can refer to benefit provisions (e.g., copays and deductibles), referral and authorization requirements for out-of-network physicians/services, and membership eligibility conditions that are provided to members via a plan contract. A subscription can refer to a record of an arrangement between an employer and an employee (also referred to herein as a subscriber), where the employee participates in a plan offered by the employer. A member service agreement can refer to any exceptions to a benefit plan for a particular member that have been approved by a health care company, such as, for example, items not addressed in a contract between the health care company and a supplier. A supplier contract can refer to an agreement between a supplier and a health care company that identifies financial and other terms (e.g., a fee to be charged for a particular service) associated with medical services. A supplier invoice (also referred to herein as a health care claim) can refer to a request for payment for services rendered to a member. A health care policy can refer to rules and behaviors specified in health care contracts, health care products, health care plans, and/or supplier contracts that define appropriate responses to specific medical service instances, such as whether a health care claim is accepted, rejected, or requires review.

In brief overview and with reference to FIG. 1, industry participants 102 (e.g., a hospital and a health care company) can interact based on provisions in one or more contractual documents 104 (e.g., fee arrangements in a supplier contract) that control, at least some, aspects of the interactions 106 between the participants 102 (e.g., a hospital contacts a health care company to pre-approve a fee for a particular medical procedure). One or more of the interactions 106 can cause the formation of an electronic message or other type of electronic document containing, for example, a request 108 for a particular transaction (e.g., a request for pre-authorization of a medical service fee for a particular member, submitted by a hospital for authorization by a health care company). The request 108 can be subsequently processed by one or more transaction processes 110, which can access data 112 associated with a semantic network to support its processing activities. A notification can be generated in response to a final resolution of the processed request (e.g., pre-authorization request of a medical service fee or a particular member is approved) by a notification process 114 to inform the industry participant 102 that submitted the request 108 and/or other interested parties of the final resolution of the request 108.

Prior to and/or during the processing of a request 108, semantic network data 112 including, for example, one or more industry-specific data structures 114, configuration-specific data structures 116, and/or transaction-specific data structures 118, are used in configuring the collaboration architecture to support such processing. Industry-specific data structures 114 can include data pertaining to entity types 120, relationship types 122, request types 124, transaction sequence types 126, and/or industry reference data 128. Entity types can refer to indicia associated with types of industry participants 102, as well as, indicia pertaining to one or more controlling documents 104 (e.g., identifiers associated with the industry participants 102 and/or controlling documents 104, affiliate information, authorization codes, names of individuals to contact, and/or any other type of data suitable for supporting/processing transactions and transaction requests). Relationship types 122 can refer to the types of relations that may exist between/among controlling documents 104, as well as, the types of contractual provisions 123 in such documents 104 that may affect interactions 106 between industry participants 102 (e.g., individual health care subscriptions can associated with particular health care plans, a health care purchaser can be associated with multiple subscribers, multiple health care plans can be associated with a single product, a subscription can be associated with a purchaser, a member can be associated with a subscription, a benefit plan can be based on a product, a membership can subscribe to a benefit plan, etc.). Request types 124 can refer to the types of requests 108 that may be transmitted from one or more industry participants 102 and/or from an administrator of the collaboration architecture 100 to a transaction process 10 (e.g., a request by a health care supplier to receive payment for services performed, a request to enroll a health care supplier, a request to enroll a health care purchaser, a request to enroll a subscription/membership, a request to enroll a practitioner, a request to submit new contract provisions for a contract between a health care company and a supplier, a request to submit provisions associated with a new agreement between a health care purchaser and a health care company, a request to query the semantic network data 112, a request to load data into the data structures 114-118 associated with the semantic network data 112, etc.). Reference data types 128 can refer to data that is specific to a particular industry and which is used in support of processing a request 108 (e.g., health care service codes, health care diagnosis codes, health care claim bundling rules, etc.). Transaction sequence types 126 can refer to various types of transaction sequences (corresponding to, for example, a set of transaction operations 127 that are to be performed in a particular order) that may be performed in support of processing requests 108. For example, types of transaction sequences 126 (relating to, for example, creating, renewing, terminating, and/or reinstating health care subscriptions) can include transaction operations 127 relating to one or more repair, analysis, consolidation, review, fulfillment, and/or notification functions.

In one illustrative embodiment, a consolidate operation of a transaction sequence can, for example, map fields and/or values contained within a request 108 to corresponding fields and/or values in a data structure 114-118 associated with the semantic network data 112; an analyze operation can, for example, access data associated with contractual provisions 123 to determine the applicability of such provisions 123 to particular requests; a review operation can correspond to, for example, a fully automated, semi-automated, or manual process of assessing fields, values, and/or data structures associated with a request that may appear problematic (erg., a review operation may be helpful in detecting fraud if, for example, an employee submits health care claims for an unusual number of dependents); a repair operation can correspond to, for example, a fully automated, semi-automated, or manual process of fixing errors and/or omissions in data contained within a request 108 and/or otherwise associated with the semantic network data 112; a fulfill operation can, for example, complete and validate values and/or data structures, which are subsequently persisted in a database and which can be made available for access to other transaction sequences; and a notify operation (that may be associated with the functions of the notification process 114) can, for example, generate a file, an electronic message, and/or other electronic document that may be used to notify an administrator and/or other user of the collaboration architecture 100 of a particular event/status (e.g., notify a subscriber about an enrollment in a benefit plan, provide an explanation of benefits to a subscriber, provide an explanation of how a fee schedule was applied to a health care claim, etc.), initiate the execution of other transaction sequences that may relate to operations within the collaboration architecture and/or external to the collaboration architecture (e.g., instruct an organization to prepare and mail identification cards and/or other printed material to new subscribers, etc.).

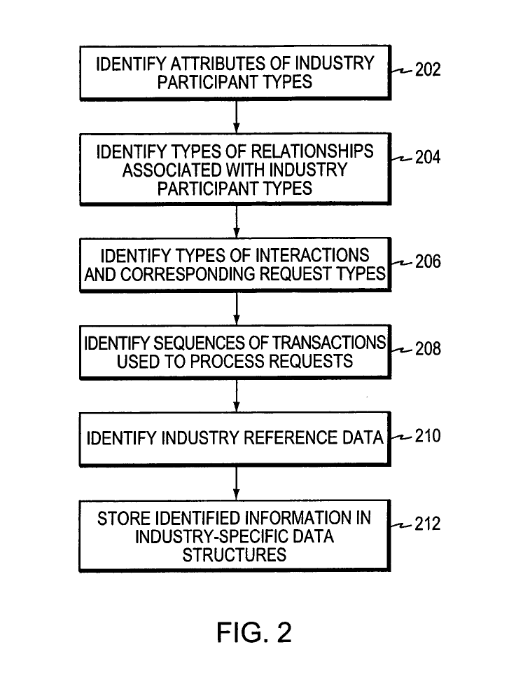

With reference now also to FIG. 2, an individual (e.g., administrator, consultant, and/or other type of authorized user of the collaboration architecture) and/or one or more software processes tasked with modeling a particular industry can identify attributes associated with types of industry participants 102 which may be useful in processing requests 108 and arrange them in a format suitable for storage within an industry-specific data structure 114 as one or more entity types 120 (202). The types of relationships that may be associated with particular types of industry participants interacting in a particular industry and which may be useful in processing requests 108 received therefrom can also be identified based, at least in part, on types of contractual provisions 123 that may be included within one or more controlling documents 104 and such identified relationships can be arranged in a format suitable for storage within an industry-specific data structure 114 as one or more relationship types 122 (204). Similarly, types of interactions that may be expected to occur between types of industry participants, as well as, the types of requests that may be generated in response to such interaction types can be identified (206) and serve as at least one basis for identifying one or more sequences of transactions that can be used to process such request types (208). Industry reference data that also supports processing of the request types can also be identified (210) and can be stored, along with the identified attributes, relationships, and transaction sequences in one or more industry-specific data structures 114 (212). The data stored within industry-specific data structures 114 can serve as a basis and/or a template for configuring the semantic network data 112 and/or for processing requests 108 associated with particular interactions 106 occurring between particular industry participants 102 and based on contractual provisions contained with particular controlling documents 104.

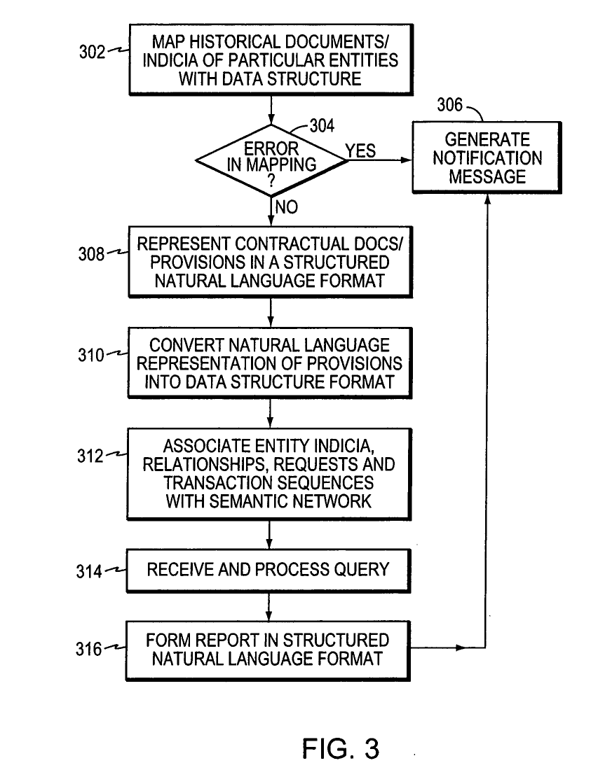

In more detail and with reference to FIGS. 1 and 3, an individual (e.g., administrator, consultant, and/or other type of authorized user of the collaboration architecture) and/or one or more software processes associated with the collaboration architecture 100 can use at least some of the data stored in the industry-specific data structures 114 as a basis for forming and/or populating the configuration-specific data structures 116 of the semantic network data 112 with data from historical documents and transactions associated with particular industry participants 102 and controlling documents 104.

In one illustrative embodiment, data associated with prior interactions 106 between industry participants 102 (e.g., data associated with existing health care members, health care companies, health care purchasers, health care practitioners, health care suppliers, health care claims, health care requests, etc.) can be provided to a converter process 130 of the collaboration architecture 100 via, for example, an electronic data interchange system, an application program interface, a software editing tool, a graphical or command line user interface, and/or via any other type of system, software, and/or interface that is capable of conveying such data. A converter process 130 can refer to a software process that receives, parses, and transforms data from a format that may be native to the system and/or software of a particular industry participant 102 into a format that is compatible with that of the configuration-specific data structures 116. The converter process 130 can further map and/or assist a user to map fields and/or values of the transformed data into corresponding fields and/or values associated with particular entities 134 in the configuration-specific data structures 116 (302). In one embodiment, the converter process 130 can be formed by executing one or more transaction sequences 136, or parts thereof (corresponding to, for example, a consolidate operation), based on one or more of the transaction sequence types 126 stored in a corresponding industry-specific data structure 114. In another embodiment, the converter process 130 can execute one or more transaction sequences 136, or parts thereof to perform some, if not all, of its parsing, transforming, and/or mapping functions. The transaction sequences 136 stored in configuration-specific data structures 116 can correspond to transaction sequences that were used to parse/transform/map data received from industry participants 102 and/or transaction sequences that were used to process a prior request 108.

Any errors that may be detected during the parsing, transforming, and/or mapping operations of the converter process 130 can be detected (304) and communicated to a notification process 114 that can generate a notification message (e.g., a system message, an electronic mail message, an electronic file, an audit log, etc.) that may inform/alert an administrator of the collaboration architecture, a corresponding industry participant, and/or any other type of authorized user of the error (306) who may then intervene by reviewing and, if possible, repairing the error and resubmitting the data to the collaboration architecture 100. In one embodiment, the notification process 114 can be formed by executing one or more transaction sequences 136, or parts thereof (corresponding to, for example, a notify operation), based on one or more of the transaction sequence types 126 stored in a corresponding industry-specific data structure 114. In another embodiment, the notification process 114 can execute one or more transaction sequences 136, or parts thereof to perform some, if not all, of its notification functions.

In addition to populating configuration-specific data structures 116 with data associated with entities 134 (e.g., industry participants 102), as described above, the configuration-specific data structures 116 can also be populated with representations of the rules, policies, and/or provisions 138 that may affect the relationships 140 and/or interactions between corresponding industry participants 102. The rules, policies, and/or provisions in the controlling documents 104 that govern and/or otherwise affect the interactions and relationships between industry participants 102 can be represented in a structured natural language format in one or more electronic documents 142 by using a software editing tool 132 (i.e., a software application program capable of performing word processing activities) that can represent such rules, policies, and/or provisions in accordance with a fixed context (corresponding to, for example, a particular task/request, such as when enrolling a health care subscriber) and a fixed grammar (corresponding to, for example, a Backus Naur format familiar to those skilled in the health care arts) (308). The natural language representations 142 of the rules, policies, and/or provisions can be designed, as further discussed below, to be readily understood by individuals without software programming experience, as well as, by a transaction process 110 and/or other types of software processes that subsequently store such natural language representations 142 in one or more configuration-specific data structures 116. The natural language representations 142 can also be converted into database tables and/or other types of data formats/structures and stored in the configuration-specific data structures 116 (310).

Unlike phrases expressed in a natural language, such as English, which can be inconsistent and incomplete in its expression, the disclosed technology applies a “structured” natural language to represent rules, policies, and/or provisions found in controlling documents 104 that affect the interactions 106 of industry participants 102. This structured natural language can use particular nouns and adjectives that correspond to certain known terms that are common in a particular industry of interest and which can provide a context that enables non-programmer individuals to understand the meaning of structured natural language representations 142. The grammatical format of the structured natural language can also be selected to correspond to certain well-known grammatical formats that may be particular to certain industries (e.g., the Backus Naur grammatical format used in the health care industry). The types of relationships 122 and types of associated contractual provisions 123 that can be supported by the disclosed technology are stored in one or more industry-specific data structures 114, thereby enabling a transaction process 110, editing tool 132, converter process 130, report generator 144, and/or any other type of process to properly interpret such structured natural language representations 142 and to ascertain a lower level set of operations/software code that is necessary to interact with and/or process requests 108 associated with such representations 142. In this manner, structured language representations of contractual rules, policies, and/or provisions can be concurrently understood by software processes and non-technical personnel, thereby mitigating human error in preparing such representations and avoiding expensive and time-consuming effort in modifying what may be significant amounts of software code to accommodate changes in the provisions of associated controlling documents 106.

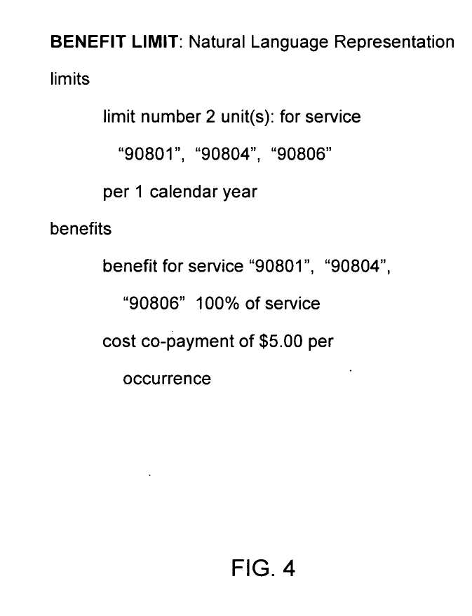

By way of non-limiting example and with respect to a health care embodiment of a structured natural language representation for a health care benefit limit as shown in FIG. 4, a non-technical person can recognize that this structured natural language representation describes a member benefit for services associated with three different service codes that are well known to those skilled in the art as pertaining to mental health visits and that a health care company will pay a health care supplier on behalf of the member, 100% of the service cost for two visits, less a $5.00 copayment per visit for each calendar year that the plan is active. Similarly, one or more of the software processes 110, 130, 132, 144 operating within the collaboration architecture 100 can recognize that terms such as “limits,” “benefits,” “member,” “calendar year,” “co-payment,” service codes and/or other terms correspond to entity types 120, relationship types 122, contractual provisions 123, request types 124, transaction sequence types 126, and/or reference data types 128 are stored in industry-specific data structures 114 and provide a fixed context for interpreting their meaning. Further, the fixed grammatical format of the structured natural language representation can be readily parsed by such software processes.

With continuing reference to FIGS. 1 and 3, indicia associated with the entities 134, along with corresponding relationship information 140, request information, and/or transaction sequences 136 can be associated to form one or instances of a semantic network (312). The configuration-specific data structures 116 containing such data can be individually associated with date-time indicia (e.g., effective start and end dates/times in which a request was processed, effective start and end dates/times for which a rule, policy and/or provision is viable, etc.), version numbers, and/or other types of indicators that enable such data structures 116 to be associated with and/or to form particular semantic network instances. The date-time indicia and/or other version information for particular configuration-specific data structures 116 (and/or other types of data structures) can also be used to identify different versions of the data structures 116 themselves.

In one illustrative embodiment, date-time indicia and/or other types of version information can be used to enable an interested party to a) process a request (e.g., a health care claim) that was delayed in its submission to the collaboration architecture 100 using the rules, policies, and/or provisions that were applicable at the time that the product and/or services (e.g., medical services) underlying the request (e.g., health care claim) were performed, b) provide an audit trail of what changed, when it changed, who changed it, and why a change occurred, c) reconstruct a particular instance of a semantic network to reprocess a request, if a particular event occurred and/or new information was received after its initial processing, d) resubmit a request for processing after it was previously denied and/or otherwise failed to complete processing, e) process a query of the semantic network data 112 to provide information pertaining to one or more historical requests, rules/policies/provisions, etc.(3 14), and/or to perform any other type of activity that requires access to different versions of data and/or data structures. The historical query capability of the disclosed technology can also be used by a report generator software process 144 to form reports and/or other types of electronic documents that contain query results, preferably in a structured natural language format 146 (316), which can be subsequently communicated to interested parties via a notification message generated by a notification process 114.

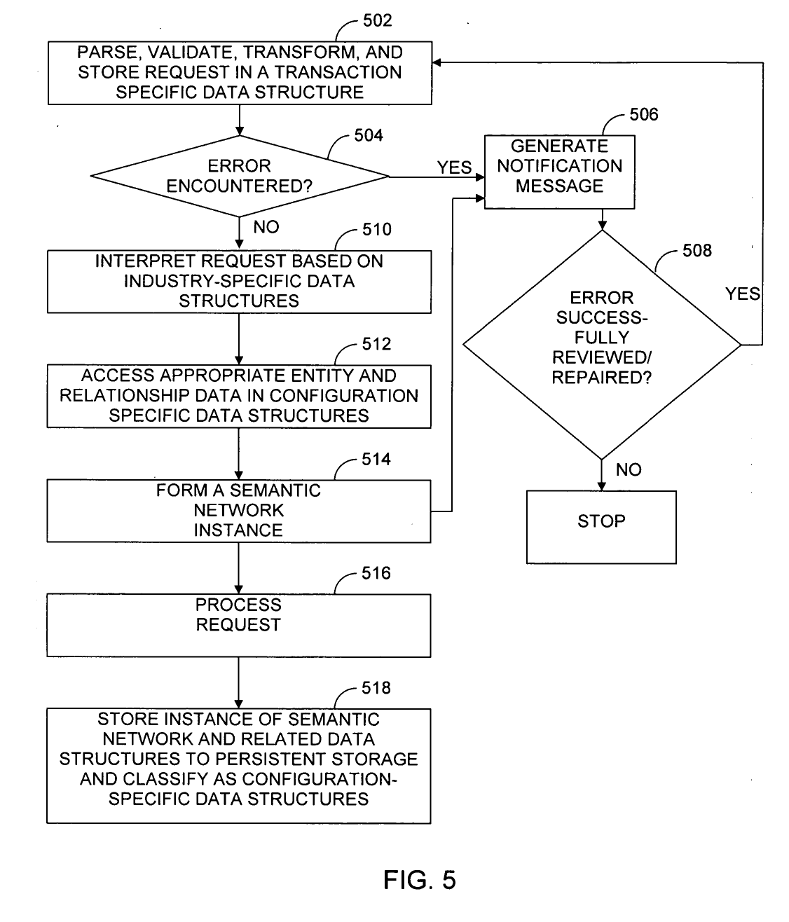

With reference now to FIGS. 1 and 5, once the semantic network data 112 has been modeled into industry-specific data structures 114 and configured into configuration-specific data structures 116 as discussed above, the collaboration architecture 100 is ready to process new requests 108 from one or more of the industry participants 102. A request 108 transmitted by an industry participant 102 and received by a converter process 130 of a collaboration architecture 100 can be parsed into particular fields and/or values, validated to ensure that such data conforms to an expected content type and format, transformed into a format compatible with the semantic network data 112, and/or mapped into the fields of one or more request data structures 148 associated with in one or more transaction-specific data structures 118 (502). The parsing, validation, transformation, mapping, and storing functions can be performed by one or more transaction operations 127 (e.g., consolidate operations) associated with particular transaction sequence types 126 identified in one or more industry-specific data structures 114. Any errors encountered during this preliminary processing activity 504 can cause the converter process 130 to generate a message to a notification process 114, which subsequently generates a notification message (using, for example, a notify operation as previously described) to a software process, an administrator, the industry participant 102 who transmitted the request 108, and/or to any other authorized and/or interested party (506). The recipient of the notification message can subsequently review/repair the error condition (using, for example, the review and repair operations as previously described) and, if successful, the corrected request can be resubmitted to the converter process 130 for further processing, or if unsuccessful, the processing transaction for this particular request can be terminated (508).

Assuming that the converter process 130 was successful in its preliminary processing activities, an instance of the initial request data structure 148 can be conveyed to a transaction process 110, which evaluates/interprets the entity, relationship, and transactional information contained within the fields of the request data structure 148 relative to the entity types 120, relationship types 122, request types 124, and/or transaction sequence types 126 (using, for example, one or more analyze operations as previously described) to determine whether the combinations of entities, relationships, and/or transactions associated with the request 108 are appropriate (510). Based on the entity types 120, relationship types 122, request types 124, and/or transaction sequence types 126, the transaction process 110 can identify and access the appropriate entity and relationship data in particular configuration-specific data structures 116 to obtain the data that pertains to the request 108 (512). The data contained within the initial request data structure 148 can be merged with the data retrieved from the identified configuration-specific data structures to form one or more intermediate data structures 150 that can be classified as transactional data structures 152 and which represent a version of the data structure that has not yet completed processing.

The applicable transaction sequences identified by the transaction process 110, and based on the types of entities 120, types of relationships 122, types of requests 124, and types of transaction sequences 126 of the industry-specific data structures 114, that were applicable to the corresponding elements of the request 108 can be executed by the transaction process 110 so that at least some of the data in the intermediate data structure 150 containing the request data and other pertinent data from the configuration-specific data structures 116 is associated and forms an instance of a semantic network 156 (514). The nodes of the semantic network instance 156 can correspond to instances of entity data structures 158 (e.g., data structures associated with the corresponding industry participants 102, as well as, data structures associated with the corresponding controlling documents 104) and the links interconnecting one or more such entity data structures 158 can correspond to the relationships associated therewith (e.g., rules, policies, and/or provisions associated with the controlling documents 104). The semantic network instance 156 can be formed, for example, within a volatile memory of a digital data processing device that is executing one or more of the aforementioned processes, operations, and/or transaction sequences and can represent an execution environment in which the request 108 is processed (516). Once the request 108 has been successfully processed, the transaction process 110 can store an instance of the semantic network 156 together with related data structures in a persistent storage memory as a final data structure 154 that can now be classified as a configuration-specific data structure 116 and which can thereafter be accessed by future requests and/or processes (518). As previously described, the request data structures, intermediate data structures, and/or final data structures that were operated on by various transaction operations associated with particular transaction sequences can be identified with distinct date-time indicia and/or other version information to facilitate reproduction of the processing activity at particular points in time and/or to facilitate querying, reprocessing, and/or other activity.

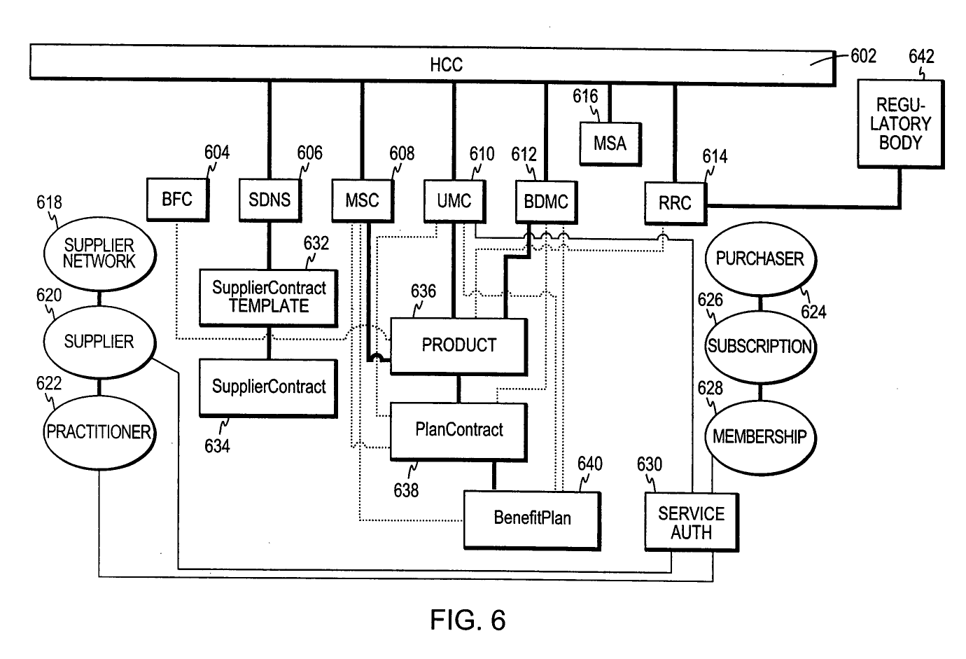

With reference to FIG. 6, a high-level representation of an illustrative semantic network pertaining to a health care embodiment that can be instantiated according to the disclosed methods and systems is shown. As provided previously, an instantiation can be based on a Health Care Company (HCC) 602. Accordingly, high-level nodes associated with the HCC can include a Benefit Funding Component (BFC) 604, a Service Delivery Network Specification (SDNS) 606, a Market Segment Component (MSC) 608, a Utilizing Management Component (UMC) 610, a Benefits Delivery Model Component (BDMC) 612, a Regulatory Requirements Component (RRC) 614, a Member Services Agreement (MSA) 616, and nodes related to a Supplier Network 618, a Supplier 620, a Practitioner 622, a Purchaser 624, a Subscription 626, a Membership 628, and a Service Authorization 630. Other nodes include a Supplier Contract Template 632, a Supplier Contract 634, a Product 636 (template of a Benefit Plan), a Plan Contract 638, and a Benefit Plan 640. As provided herein, such nodes can represent tables, and the associated lines/connections can represent, for example, relationships between nodes in the form of ownership (solid, heavy lines), relationships based on semantics (dotted lines), and nodes representing entities that participate together (solid, light lines).

Those of ordinary skill in the art will recognize that the illustrative FIG. 6 high-level representation of a semantic network in accordance with a health care embodiment of the disclosed methods and systems provides one basis for one embodiment of a semantic network, and other high-level nodes can be employed in other high-level descriptions. Accordingly, it is also understood that the depicted high-level nodes 604-640 can be further partitioned into sub-nodes, which sub-nodes may then be further partitioned into other sub-nodes, and such hierarchical structure can be implemented using nodes and sub-nodes in accordance with a hierarchical structured natural language representation of the communications, contracts, agreements, and other provisions upon which the semantic network is based.

Referring again to FIG. 6, the Benefit Funding Component (BFC) 604 can be a high-level node that can decompose into series of sub-nodes that describe the processes and relationships for self-insured companies, for example, to determine which party shall pay the benefit. The illustrated Service Delivery Network Specification (SDNS) 606 can be decomposed into sub-nodes that describe, for example, fee schedules and billing terms, and can be based on templates of provider contracts. The Market Segment Component (MSC) 608 can include information shared by, for example, members of a plan such as a Health Maintenance Organization (HMO), and can include policy information or data. The illustrated Utilization Management Component (UMC) 610 can be decomposed into sub-nodes that provide data for services that may need prior authorization, for example, approval to see a specialist. The FIG. 6 Benefit Delivery Model Component (BDMC) 612 can be decomposed into nodes representing the benefit plan that describe the benefits and bounds under which the benefits can be administered.

In the FIG. 6 representation, the Member Service Agreement (MSA) 616 can be decomposed to represent exceptions to general rules that can represent, for example, when a member negotiates coverage or other terms with the insurer or health care company 602, and where such terms may provide an exception to the contract or agreement that may otherwise exist between the member and the insurer 602. In some embodiments, the MSA 616 may include exception conditions to not only member-insurer agreements, but also exceptions to other agreements. In other embodiments, additional and/or optional other high-level nodes can be incorporated into the FIG. 6 embodiment to represent a decomposition of exception conditions for other agreements such as agreements between providers and the health care company 602, etc.

The FIG. 6 embodiment also includes a high-level representation of a Regulatory Requirement Component (RRC) 614 that can be based on documents, agreements, contracts, regulations, or other provisions that can be provided by or otherwise associated with a Regulatory Body 642. For example, regulations provided by the Regulatory Body 642 can be converted to a structured natural language representation that can be converted to specific instances of nodes and links in the illustrated semantic network of FIG. 6. Accordingly, the RRC 614 illustrates a high-level node that can be decomposed into sub-nodes, and as provided previously herein, such sub-nodes can be sub-divided accordingly until such high-level node and associated sub-nodes are decomposed to a desired level. Those with ordinary skill in the art will recognize that such decomposition, as provided previously herein, is applicable to the various illustrated high-level nodes 604-642 in the FIG. 6 embodiment.

The FIG. 6 illustrative embodiment of a high-level semantic network also incorporates a similar decomposition of the agreements that may be applicable to providers and suppliers, where such agreements may be tangential to agreements with the health care company 602. For example, as provided herein, in a health care embodiment as shown in FIG. 6, a practitioner 622 (e.g., doctor) can be associated with a supplier 620 (e.g., hospital) that may further be associated with a supplier network 618 (e.g., HMO). One of ordinary skill in the art will recognize that these nodes represent agreements associated with such entities rather than the entities themselves, and other such nodes to be provided herein that reference an entity, can be understood to represent contracts, agreements, communications, etc., associated with such entities rather than the entities themselves. Such communications, agreements, and other provisions can thus also be represented in a structured natural language representation to provide instances of nodes and links of the illustrated semantic network. Although the FIG. 6 embodiment indicates that there is only one supplier network 618, one supplier 620, and one practitioner 622, and that there is an illustrated relation between the supplier 620 and a service authorization 630, and similarly a relationship between the practitioner 622 and the service authorization 630, those with ordinary skill in the art will recognize that an instantiation of a semantic network according to the disclosed methods and systems and for which FIG. 6 is one representation, that is based upon an insurer (e.g., health care company 602), can include one or more practitioners 622 that may be associated with one or more suppliers 620 that may be further associated with one or more supplier networks 618, one or more of which may have relationships with other entities (e.g., nodes). As provided previously herein, the FIG. 6 nodes are merely illustrative and are not intended to exemplify the numerous combinations, variations, and/or repetitions of illustrated and non-illustrated concepts that may otherwise be provided herein. Similarly, the connections and/or relations provided by the FIG. 6 illustration are also merely illustrative of one embodiment, or a part of one embodiment, and one of ordinary skill in the art will recognize that such relations and/or connections can be varied depending upon the embodiment.

Referring again to FIG. 6, there is a representation of a purchaser 624 (e.g., member, member dependent, etc.) that can have a contractual or other agreement relationship with a subscription 626 that can be associated with a membership 628. The illustrated membership 628 maintains a relationship to the service authorization 630 that maintains relationships to the utilizing management component (UMC) 610 that includes, as previously provided herein, decompositions of data and/or information regarding services requiring authorization. For example, the illustrated service authorization 630 can determine whether benefits may be provided although a given benefit plan does not provide for such benefits (e.g., should the benefit plan be overridden?).

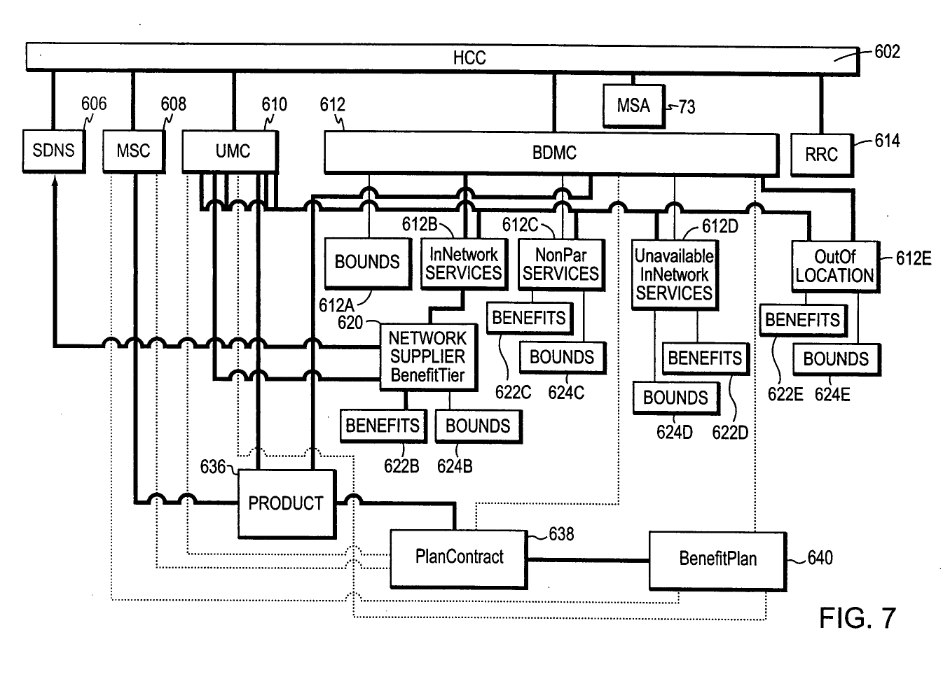

FIG. 7 provides another representation of a semantic network that provides varying detail when compared to the embodiment of FIG. 6. For example, FIG. 7 includes a representation that includes high-level sub-nodes for the high-level node representing the Benefit Delivery Model Component (BDMC) 612. As shown in FIG. 7, the BDMC 612 can be subdivided into several sub-nodes that include Bounds 612A, In Network Services 612B, Non Participating Services (NonPar) 612C, Unavailable In Network Services 612D, and Out of Location Services 612E, where such sub-nodes are not exhaustive and are merely illustrative of sub-nodes that may be used, and one of ordinary skill in the art will recognize that fewer, more, or combinations thereof of such sub-nodes may be used depending upon the embodiment. In the illustrated system, for example, Bounds 612A can be further decomposed into sub-nodes for limits, exclusions, maximums, and deductibles, while In Network Services 612B can be subdivided as shown into at least one sub-node that may include, for example, a Network Supplier Benefit Tier node 620 that can be further subdivided into a Benefits node 622B and a Bounds node 624B, where such nodes may be further subdivided as provided herein, to decompose the nodes to one or more sub-levels. Similarly, Non Participating Services 612C, which may include out of network benefit services, can similarly be subdivided into sub-nodes based on benefits 622C and bounds 624C. Non Participating Services 612C can represent a node that can be decomposed to represent relationships and conditions related to services provided by a doctor, for example, outside of the network. Unavailable In Network Services 612D can be a high-level node representing the services that are unavailable in the network, and for which reimbursement and/or benefits may be paid even though a member received the services outside of the network. Out of Location 612E can be subdivided into sub-nodes based on services that could not be provided in the network because the member was outside the geographical region of the network, for example. As shown in FIG. 7, some sub-nodes for the aforementioned nodes can include a benefits node 622D-E and a bounds node 624D-E, respectively, as shown, while such nodes can be further decomposed into sub-nodes, and such nodes are not intended to be exhaustive of sub-nodes that can be at the illustrated sub-node level.

The various software processes, transaction sequences, transaction operations, entity types, and/or other elements of the collaboration architecture 100 can be performed and/or can be otherwise associated with one or more digital data processing devices that may be interconnected by a network. Those skilled in the art will recognize that a digital data processing device can be a personal computer, computer workstation (e.g., Sun, HP), laptop computer, server computer, mainframe computer, handheld device (e.g., personal digital assistant, Pocket PC, cellular telephone, etc.), information appliance, or any other type of generic or special-purpose, processor-controlled device capable of receiving, processing, and/or transmitting digital data. A processor refers to the logic circuitry that responds to and processes instructions that drive digital data processing devices and can include, without limitation, a central processing unit, an arithmetic logic unit, an application specific integrated circuit, a task engine, and/or any combinations, arrangements, or multiples thereof.

The instructions executed by a processor represent, at a low level, a sequence of “0's” and “1's” that describe one or more physical operations of a digital data processing device. These instructions can be pre-loaded into a programmable memory (not shown) (e.g., EEPROM) that is accessible to the processor 122 and/or can be dynamically loaded into/from one or more volatile (e.g., RAM, cache, etc.) and/or non-volatile (e.g., hard drive, etc.) memory elements communicatively coupled to the processor. The instructions can, for example, correspond to the initialization of hardware within a digital data processing device, an operating system that enables the hardware elements to communicate under software control and enables other computer programs to communicate, and/or software application programs/software processes that are designed to perform particular functions for an entity or other computer programs, such as functions relating to processing requests from industry participants in a collaboration architecture.

A local user can interact with a digital data processing device by, for example, viewing a command line, graphical, and/or other user interface and entering commands via an input device, such as a mouse, keyboard, touch sensitive screen, track ball, keypad, etc. The user interface can be generated by a graphics subsystem of a digital data processing device, which renders the interface into an on or off-screen surface (e.g., in a video memory and/or on a display screen). Inputs from the user can be received via an input/output subsystem and routed to a processor via an internal bus (e.g., system bus) for execution under the control of the operating system.

Similarly, a remote user can interact with a digital data processing device over a data communications network. The inputs from the remote user can be received and processed in whole or in part by a remote digital data processing device collocated with the remote user. Alternatively or in combination, the inputs can be transmitted back to and processed by the local digital data processing device or to another digital data processing device via one or more networks using, for example, thin client technology. The user interface of the local digital data processing device can also be reproduced, in whole or in part, at the remote digital data processing device collocated with the remote user by transmitting graphics information to the remote device and instructing the graphics subsystem of the remote device to render and display at least part of the interface to the remote user. Network communications between two or more digital data processing devices typically require a network subsystem (e.g., as embodied in a network interface card) to establish the communications link between the devices. The communications link interconnecting digital data processing devices can include elements of a data communications network, a point to point connection, a bus, and/or any other type of digital data path capable of conveying processor-readable data.

A data communications network can comprise a series of network nodes that can be interconnected by network devices and communication lines (e.g., public carrier lines, private lines, satellite lines, etc.) that enable the network nodes to communicate. The transfer of data (e.g., messages) between network nodes can be facilitated by network devices, such as routers, switches, multiplexers, bridges, gateways, etc., that can manipulate and/or route data from a source node to a destination node regardless of any dissimilarities in the network topology (e.g., bus, star, token ring), spatial distance (local, metropolitan, or wide area network), transmission technology (e.g., TCP/IP, Systems Network Architecture), data type (e.g., data, voice, video, or multimedia), nature of connection (e.g., switched, non-switched, dial-up, dedicated, or virtual), and/or physical link (e.g., optical fiber, coaxial cable, twisted pair, wireless, etc.) between the source and destination network nodes.

In one particularly advantageous embodiment, the disclosed technology can be implemented, at least in part, using a Java 2 platform, Enterprise Edition (produced by Sun Microsystems, Inc.) and other related components (e.g., Java programming language, Java Server Pages and Serviets, Enterprise Java Beans, Simple Object Access Protocol, Extensible Markup Language, and/or Extensible Stylesheet Language Transformations).

Although the disclosed technology has been described with reference to specific embodiments, it is not intended that such details should be regarded as limitations upon the scope of the invention, except as and to the extent that they are included in the accompanying claims.

1. A method, comprising:
receiving a request to change a relationship associated with a plurality of entities interacting within an industry;
parsing the change request to identify a data structure associated with the industry, the data structure including a plurality of entity types and relationship types;
based on at least some of the plurality of entity types and relationship types corresponding to the plurality of entities, identifying a sequence of transactions; and
executing the transaction sequence to process the requested relationship change.

2. The method of claim 1, wherein the request corresponds to an electronic document having a natural language format with a fixed context and a fixed grammar.

3. The method of claim 2, wherein the fixed grammar corresponds to a Backus-Naur format.

4. The method of claim 1, wherein the industry is a service-based industry and the entity types corresponding to at least two of the plurality of entities correspond to at least two of a service provider, a service implementer, a service purchaser, a service beneficiary, a service maintainer, and a service regulator.

5. The method of claim 1, wherein the industry corresponds to a health care industry and the entity types corresponding to at least two of the plurality of entities correspond at least two of a health care subscriber, a health care provider, a health care practitioner, a health care beneficiary, and a health care company.

6. The method of claim 5, wherein the request corresponds to at least one of a request for payment of services performed, a request to authorize proposed services, a request to enroll the health care provider, a request to enroll the health care subscriber, a request to enroll the health care beneficiary, and an adoption of a new contract.

7. The method of claim 1, wherein the industry is a product-based industry and the entity types corresponding to at least two of the plurality of entities correspond to at least two of a product manufacturer, a product distributor, a product reseller, a product marketer, a product seller, a product purchaser, a product maintainer, and a product regulator.

8. The method of claim 1, further comprising:
storing indicia associated with the change request in a first data structure; and
assigning a version number to the first data structure.

9. The method of claim 8, further comprising:
based, at least in part, on the version number of the first data structure, re-executing at least some of the transaction sequence to reprocess the requested relationship change.

10. The method of claim 1, wherein the request is received from an electronic data interchange system.

11. The method of claim 1, wherein the request is received from at least one of an application program interface, a user interface, and a software editing tool.

12. The method of claim 1, wherein parsing the change request comprises:
parsing a natural language representation of the request into a plurality of fields; and
mapping at least some of the fields into at least one database table.

13. The method of claim 1, wherein the requested relationship change corresponds to at least one contractual provision associated with the plurality of entities.

14. The method of claim 1, further comprising:
forming an electronic message in response to detecting an error during the execution of the transaction sequence.

15. The method of claim 1, wherein indicia associated with the plurality of entities correspond to a plurality of nodes in a semantic network and the requested relationship change corresponds to at least one link interconnecting at least some of the plurality of nodes in the semantic network.

16. The method of claim 15, further comprising:
querying the semantic network to obtain data associated with the plurality of entities and the requested relationship change; and
formatting at least some of the obtained data in a natural language format exhibiting a fixed context and a fixed grammar.

17. The method of claim 15, further comprising:
in response to the execution of at least part of the transaction sequence, forming an instance of the semantic network.
